(19) United States
(12) Patent Application Publication
(10) Pub. No.: US 2015/0262159 A1
(43) Pub. Date: Sep. 17, 2015

(54) MERCHANDISE SALES DATA PROCESSING DEVICE AND PROGRAM

(71) Applicant: TOSHIBA TEC KABUSHIKI KAISHA, Tokyo (JP)

(72) Inventors: Tomonari Kakino, Fuji (JP); Koji Tanimoto, Tagata (JP); Nobuhiko Nakahara, Mishima (JP); Kenichi Komiya, Kawasaki (JP); Yasuo Matsumoto, Numazu (JP); Kazuhiro Hara, Numazu (JP); Eiji Gumbe, Yokohama (JP); Takahisa Ikeda, Shizuoka (JP); Norimasa Ariga, Shizuoka (JP); Hirofumi Harada, Funabashi (JP)

(21) Appl. No.: 14/635,020

(22) Filed: Mar. 2, 2015

(30) Foreign Application Priority Data
Mar. 17, 2014 (JP) 2014-052883

(51) Int. Cl. G06Q 20/20

(52) U.S. Cl. CPC G06Q 20/207

(57) ABSTRACT

A merchandise sales data processing device includes a specification unit, a detection unit, a calculation unit, and a processing unit. The specification unit specifies merchandise. The detection unit detects information related to an ingredient which is contained in specified merchandise. The calculation unit calculates a tax amount which is imposed on merchandise based on the detected ingredient information. The processing unit processes sales data of merchandise using the calculated tax amount.

### CROSS-REFERENCE TO RELATED APPLICATION

This application is based upon and claims the benefit of priority from Japanese Patent Application No. 2014-052883, filed Mar. 17, 2014, the entire contents of which are incorporated herein by reference.

### FIELD

Embodiments described herein relate generally to a merchandise sales data processing device such as a Point of Sales (POS) terminal, an electronic cash register, or the like, and a program thereof.

### BACKGROUND

There is a tax which is imposed on consumables such as merchandise, service, or the like. Usually, there is a taxation method of imposing a uniform tax rate with respect to all consumables, and a taxation method of changing a tax rate with respect to a specific merchandise or service. As a merchandise sales data processing device corresponding to the latter taxation method, in the related art, a device which includes a database in which a tax rate is set for each piece of merchandise is known. In such a processing device, when sales of merchandise are registered, the tax rate of the merchandise is detected from the database. In addition, the processing device calculates a tax amount based on the tax rate, further calculates a tax-included sale amount of money, and performs processing of merchandise sales data.

Meanwhile, in recent years, related to the topic of health measures, there is a movement to impose tax on foodstuff according to the harmfulness to health thereof. When such a taxation system is introduced, it is predicted that even in foodstuffs of the same price, the tax amounts become different depending on the amount of specific ingredients which are contained in the foodstuffs. The development of a merchandise sales data processing device which can also handle such a taxation method is expected.

JP-A-2012-181752 is an example of the related art.

### DESCRIPTION OF THE DRAWINGS

FIG. 1 is a block diagram which illustrates a configuration of the main portions of a merchandise sales data processing device.

FIG. 2 is a schematic diagram which illustrates an example of a barcode which is attached to a foodstuff.

FIG. 3 is a schematic diagram which illustrates the structure of the main portions of merchandise sale data which is registered in a transaction memory.

FIG. 4 is a flowchart which illustrates the main procedures of a merchandise registration process which is executed by a CPU.

FIG. 5 is a schematic diagram which illustrates an example of a layout of a merchandise registration screen.

FIG. 6 is a schematic diagram which illustrates one example of issuing a receipt.

### DETAILED DESCRIPTION

A problem to be solved by one embodiment is to provide a merchandise sales data processing device which can cope with a taxation method in which, when prices of merchandise are the same, the tax amount changes depending on the amounts of specific ingredients which are contained in the merchandise.

According to one embodiment, a merchandise sales data processing device includes a specification unit, a detection unit, a calculation unit, and a processing unit. The specification unit specifies merchandise. The detection unit detects information related to ingredients which are contained in specified merchandise. The calculation unit calculates a tax amount which is imposed on merchandise based on the detected ingredient information. The processing unit processes sales data of merchandise using the calculated tax amount.

Hereinafter, an embodiment of a merchandise sales data processing device which can cope with a taxation method in which a tax is imposed on a foodstuff according to harmfulness to health will be described with reference to drawings.

In addition, in the embodiment, as the method of determining harmfulness to health, calorie C is suggested. The calorie C which is contained in a merchandise (foodstuff) is calculated by multiplying calorie density D of the merchandise by a weight W of the merchandise. The calorie density D is determined in advance in each piece of merchandise based on ingredients, or the like, of the merchandise. Therefore, in the embodiment, a tax amount T is calculated using the following arithmetic expression (1).

T=C×(D/1000) (1)

Here, a coefficient (D/1000) denotes a tax rate. That is, in the embodiment, 1/1000 of the calorie density D is set to a tax rate. For example, the tax rate may be 1/500 of the calorie density D. The tax rate may be 1/100 of the calorie density D. The determination method of the tax rate is arbitrary.

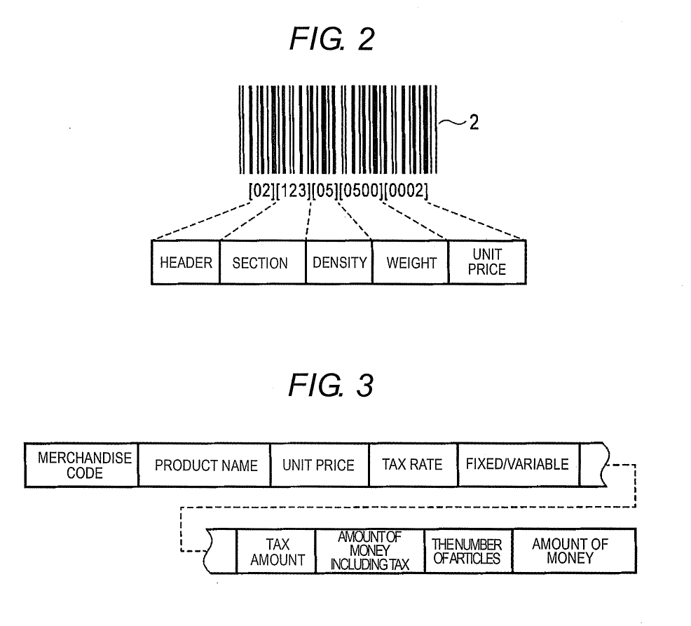

In addition, in the embodiment, a case in which a barcode 2 of in-store marking as illustrated in FIG. 2 is attached to a foodstuff, and the foodstuff is sold is exemplified. In the barcode 2, a fifteen-digit merchandise code is made as a barcode, and in the merchandise code, the first two digits denote a header which specifies that the merchandise is a foodstuff, the third to fifth digits denote a section into which the foodstuff is classified, the sixth and seventh digits denote calorie density D of the foodstuff, the eighth to eleventh digits denote weight W, and the last four digits denote price (unit price). Incidentally, descriptions will be continued by assuming that a barcode of a merchandise code such as the JAN code, or the like, is attached to merchandise other than a foodstuff.

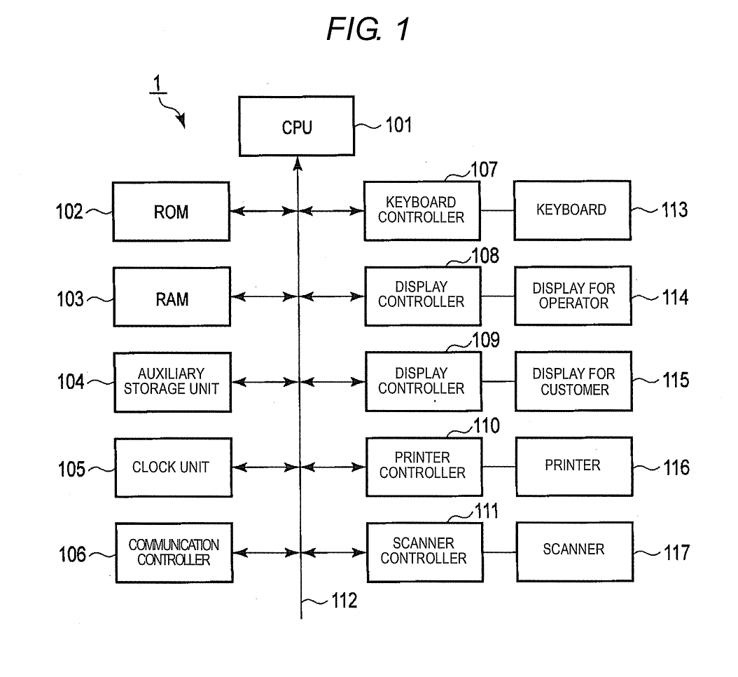

FIG. 1 is a block diagram which illustrates a configuration of main portions of a merchandise sales data processing device 1 (hereinafter, abbreviated as processing device 1). The processing device 1 includes a Central Processing Unit (CPU) 101, a Read Only Memory (ROM) 102, a Random Access Memory (RAM) 103, an auxiliary storage unit 104, a clock unit 105, a communication controller 106, a keyboard controller 107, a display controller 108, a display controller 109, a printer controller 110, a scanning controller 111, and the like. In addition, the processing device 1 includes a bus line 112 which includes an address bus, a data bus, or the like. The bus line 112 connects the CPU 101, the ROM 102, the RAM 103, the auxiliary storage unit 104, the clock unit 105, and each of the controllers 106 to 111.

The processing device 1 includes a keyboard 113 as an input-output unit, a display for operator 114, a display for customer 115, a printer 116, and a scanner 117. It may be a configuration in which the display for operator 114 is set as a touch panel, and the touch panel is used as a substitute for a portion of operation keys of the keyboard 113.

In the keyboard 113, numeric keys, a section key, a subtotal key, a total key (deposit-current total, current total, credit, or the like), a discount key, and the like, are arranged as keys related to a merchandise sales data process. The display for operator 114 displays merchandise sale data for a cashier who is an operator of the processing device 1. The display for customer 115 displays merchandise sale data with respect to a shopper. The printer 116 prints a receipt, and issues the receipt. The scanner 117 optically reads the barcode 2 which is attached to merchandise.

The keyboard controller 107 controls the keyboard 113, and takes in a key signal corresponding to the operation key. The display controller 108 controls screen display with respect to the display for operator 114. The display controller 109 controls screen display with respect to the display for customer 115. The printer controller 110 outputs receipt data to the printer 116, and controls driving of the printer 116. The scanner controller 111 controls the scanner 117, and takes in barcode data which is read using the scanner 117.

The CPU 101 corresponds to a brain portion of a computer. The CPU 101 controls each unit in order to execute various functions as the processing device 1, according to an operating system or an application program.

The ROM 102 corresponds to a main storage portion of the above described computer. The ROM 102 stores the above described operating system or the application program. There also is a case in which the ROM 102 stores data which is necessary when the CPU 101 executes processes for controlling each unit.

The RAM 103 corresponds to a main storage portion of the above described computer. The RAM 103 stores data which is necessary when the CPU 101 executes processes. In addition, the RAM 103 is also used as a work area in which information is appropriately rewritten by the CPU 101.

The auxiliary storage unit 104 corresponds to an auxiliary storage portion of the above described computer. The auxiliary storage unit 104 is, for example, an Electric Erasable Programmable Read-Only Memory (EEPROM), a Hard Disc Drive (HDD), a Solid State Drive (SSD), or the like. The auxiliary storage unit 104 keeps data which is used when the CPU 101 performs various processes, or data which is generated due to a process in the CPU 101. There also is a case in which the auxiliary storage unit 104 stores the above described application program.

The clock unit 105 counts the present date and time.

The communication controller 106 controls data communication with a store server which is connected through a network such as a Local Area Network (LAN).

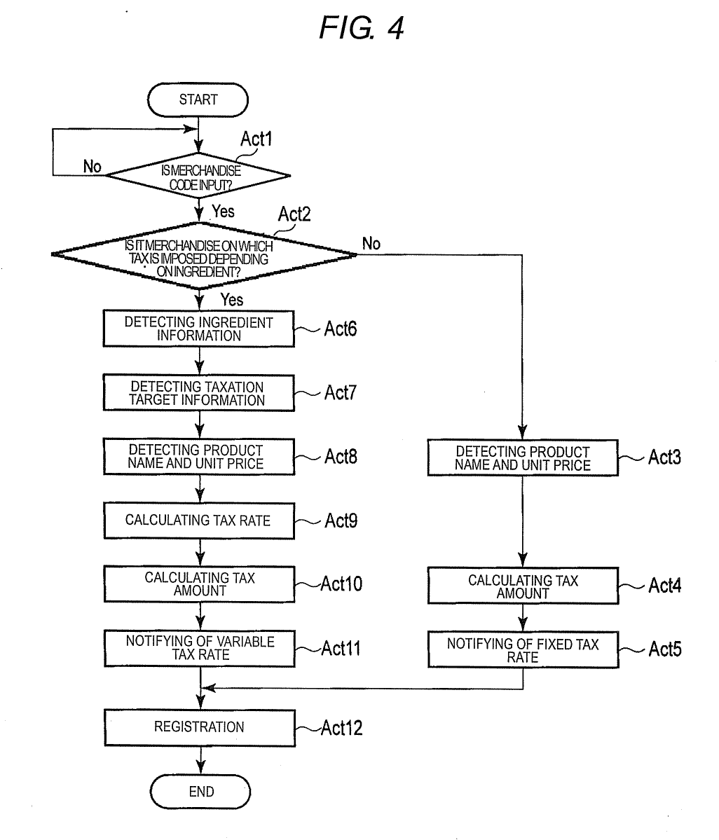

In the processing device 1 which is configured in this manner, a program for processing merchandise sale data in the procedure which is illustrated in the flowchart in FIG. 4 is installed in the CPU 101. The program is stored in the ROM 102. Alternatively, the program may be stored in the auxiliary storage unit 104, and may be developed in a program area of the RAM 103 by being read from the auxiliary storage unit 104 during start up. In addition, contents of the processes which are illustrated in FIG. 4, and are described below are examples, and it is also possible to appropriately use various processes from which the same result can be obtained.

The CPU 101 receives input of a merchandise code (Act 1: specification unit). A merchandise code is input when a barcode which is attached to merchandise is read using the scanner 117. It is also possible to input a merchandise code using a key operation of the keyboard 113. The CPU 101 repeats the process in Act 1 until a merchandise code is input.

When a customer asks for a settlement of a commercial transaction, an operator who operates the processing device 1, that is, a cashier first inputs a merchandise code of merchandise which the customer buys to the processing device 1. That is, when a barcode is attached to merchandise, the cashier causes the scanner 117 to read the barcode. When a barcode is not attached to merchandise, the cashier manually inputs a merchandise code by operating the keyboard 113.

When a merchandise code is input (Yes in Act 1), the CPU 101 confirms whether or not the merchandise is merchandise on which a tax is imposed due to an ingredient, that is, a so-called foodstuff (Act 2). In a merchandise code of a foodstuff, the first two digits become a header which specifies a foodstuff. Accordingly, the CPU 101 checks the first two digits of a merchandise code.

When the first two digits of the merchandise code are not the header which specifies a foodstuff, the merchandise which is specified by the input merchandise code is not a foodstuff. In this case (No in Act 2), the CPU 101 detects a unit price of merchandise based on the merchandise code. For example, the CPU 101 retrieves a merchandise file in which merchandise data such as a product name, and a unit price are preset in association with a merchandise code of each merchandise, and detects a product name and a unit price of the merchandise. The merchandise file is stored in the auxiliary storage unit 104. It may be a configuration in which a store server manages the merchandise file, the CPU 101 makes an inquiry about merchandise data with respect to the store server through a network, and a product name, a unit price, or the like, is detected.

When the unit price is detected, the CPU 101 calculates a tax amount by multiplying the unit price by a tax rate which is set in advance (Act 4). In addition, the CPU 101 sends notification of the fact that the tax rate of the merchandise is fixed (Act 5). A notification operation will be described later. Processing procedures of Act 4 and Act 5 may be reversed.

When the first two digits of a merchandise code are a header which specifies a foodstuff, the merchandise which is specified by the input merchandise code is a foodstuff (Yes in Act 2). In this case (Yes in Act 2), the CPU 101 detects calorie density D from the merchandise code from ingredient information of the foodstuff (Act 6). In addition, the CPU 101 detects weight W from the merchandise code as taxation target information of the foodstuff (Act 7). In addition, the CPU 101 detects a product name and a unit price A of the foodstuff (Act 8). As described in FIG. 2, a section and a unit price A are included in a merchandise code which is attached to a foodstuff. Accordingly, the CPU 101 detects a section and a unit price A from a merchandise code. In addition, the CPU 101 regards a section name (meat, fresh fish, or the like) which is set in advance with respect to a section as a product name. In addition, procedures of Act 6 to Act 8 are not limited to this, and may be reversed in order.

When the calorie density D, the weight W, and the like, are detected, the CPU 101 calculates a tax rate R (Act 9). In the embodiment, the tax rate R is 1/1000 of the calorie density D. When the tax rate R is calculated, the CPU 101 calculates a tax amount based on the tax rate. That is, the CPU 101 calculates the total calorie C by multiplying the weight W by the calorie density D, and calculates a tax amount T by multiplying the total calorie C by the tax rate R (Act 10: calculation unit). In addition, the CPU 101 notifies of the fact that a tax rate of the merchandise is variable (Act 11). Also the notification operation will be described later. Processing procedures of Act 10 and Act 11 may be reversed.

When the fixed tax rate is notified in the process in Act 5, or when the variable tax rate is notified in the process in Act 11, the CPU 101 generates merchandise sale data. In addition, the CPU 101 registers the merchandise sale data in a transaction memory of the RAM 103 (Act 12: processing unit).

FIG. 3 is a schematic diagram which illustrates the structure of merchandise sale data. As illustrated, the merchandise sale data includes each item such as a merchandise code, a product name, a unit price, a tax rate, a flag for distinguishing a fixed tax rate from a variable tax rate, a tax amount, an amount of money including tax, the number of articles, and the amount of money. The flag for distinguishing is a flag which distinguishes whether a tax rate is a fixed tax rate or a variable tax rate.

When merchandise is merchandise other than a foodstuff, amount of tax which is imposed on consumption of merchandise of which a tax rate is a preset fixed tax rate is calculated. Accordingly, the flag for distinguishing denotes a value which is a fixed tax rate, for example, “0”.

When merchandise is a foodstuff, a tax rate R is calculated from ingredient information of the merchandise (calorie density D in the embodiment). The ingredient information varies depending on the foodstuffs. That is, the tax rate R changes depending on the foodstuffs. Accordingly, the flag for distinguishing denotes a value which is a variable tax rate, for example, “1”. Incidentally, the amount of money including tax is an amount of money in which a tax amount is added to a unit price, the number of articles is the number of articles sold, and the amount of money is a sales amount which is calculated by multiplying the amount of money including tax by the number of articles sold.

When the merchandise sale data is registered, the CPU 101 ends processes with respect to the merchandise code which is input. The CPU 101 executes each process in Act 2 to Act 12 every time a merchandise code is input.

When a cashier ends an input of a merchandise code of merchandise which one customer buys, the cashier declares a registration close by operating a closing key of the keyboard 113. When the registration close is declared, the CPU 101 generates receipt data based on the merchandise sale data stored in the transaction memory. In addition, the CPU 101 outputs the receipt data to the printer 116, and causes the printer to print and issue a receipt. In this manner, the settlement of a commercial transaction with respect to one customer ends.

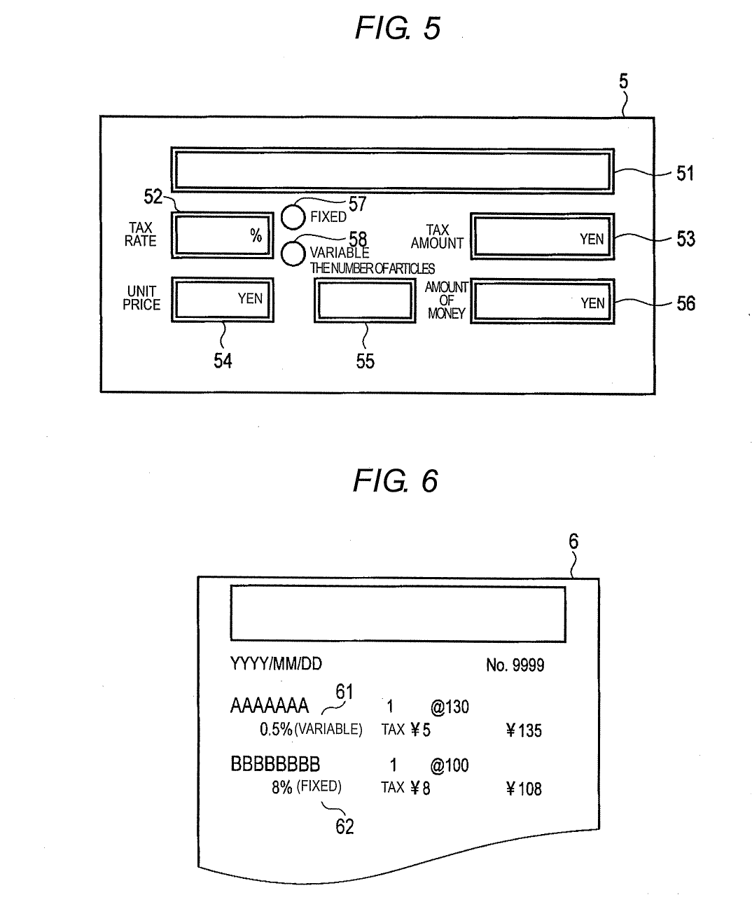

FIG. 5 illustrates an example of a merchandise registration screen 5 which is displayed on the display for operator 114 and the display for customer 115. On the merchandise registration screen 5, each of display columns 51, 52, 53, 54, 55, and 56 which are a product name, a tax rate, a tax amount, a unit price, the number of articles, and an amount of money are formed. In addition, the fixed lamp 57 and the variable lamp 58 are formed.

When a product name and a unit price are detected in the process in Act 3 or Act 8, the CPU 101 causes the product name and the unit price to be displayed on the display columns 51 and 54. In addition, when the tax amount is calculated based on a tax rate in the process in Act 4 or Act 10, the CPU 101 causes the tax rate and the tax amount to be displayed on the display columns 52 and 54. At this time, the CPU 101 causes a fixing lamp 57 to be turned on, or to blink as the process in Act 5. Alternatively, as the process in Act 11, the CPU 101 causes a variable lamp 58 to be turned on. In addition, in the process in Act 12, the CPU 101 causes the number of articles and the amount of money for the merchandise sale data to be displayed on the display columns 55 and 56.

In this manner, when merchandise as a registration target is not merchandise on which a tax is imposed depending on an ingredient, the processing device 1 notifies a cashier and a customer of the fact that the tax rate is fixed by causing the fixing lamp 57 to be turned on, or to blink. In contrast to this, when merchandise as a registration target is merchandise (foodstuff) on which a tax is imposed depending on the ingredients, the processing device 1 notifies a cashier and a customer of the fact that a tax rate is variable by causing the variable lamp 58 to be turned on, or to blink. Accordingly, the cashier and the customer can easily distinguish whether or not the registered merchandise is merchandise on which a tax is imposed depending on the ingredients with the fixing lamp 57 and the variable lamp 58.

In addition, the merchandise registration screen 5 is not limited to the layout which is illustrated in FIG. 5. The merchandise registration screen may have any layout by which it is possible for a user (cashier, customer, or the like) to recognize a product name, a tax rate, a tax amount, a unit price, the number of articles, and an amount of money, respectively. In addition, displaying of all of the items is not essential, and for example, any one or both of the tax rate and tax amount may not be displayed.

FIG. 6 illustrates a printed example of a receipt 6. In the example, the receipt 6 which is issued with respect to a customer who bought a foodstuff denoted by [AAAAAAA], and merchandise other than the foodstuff denoted by [BBBBBBBB] is illustrated. As illustrated in FIG. 6, a text “variable” 61 denoting that a tax rate is variable is printed with respect to the foodstuff [AAAAAAA]. On the other hand, a text “fixed” 62 denoting that a tax rate is fixed is printed with respect to the merchandise [BBBBBBBB] other than the foodstuff. Accordingly, it is possible for a customer to easily recognize whether or not the bought merchandise is merchandise (foodstuff) on which a tax is imposed depending on the ingredients only by glancing at the receipt.

In this manner, in the processing device 1 according to the embodiment, it is possible to easily understand a taxation method in which a tax amount is changed according to an amount of a specific ingredient contained in merchandise even when prices are the same.

In addition, the exemplary embodiment is not limited to the above described embodiment.

For example, in the above described embodiment, the barcode 2 with the data structure illustrated in FIG. 2 is attached to a foodstuff; however, a two-dimensional data code may be attached instead of a barcode. Alternatively, it may be a configuration in which an RFID tag label in which a merchandise code is kept in an IC chip is attached to a foodstuff, an RFID reader is mounted on the processing device 1, and an input of the merchandise code is received when data of the RFID tag label is read in a non-contact manner.

In addition, in the embodiment, ingredient information is set regarding calorie density; however, the ingredient information is not limited to the calorie density. For example, it may be density of any one of saturated fatty acid, sugar, and salt. Alternatively, a tax rate may be calculated based on at least two items of saturated fatty acid, sugar, salt, and calories.

In addition, in the embodiment, the weight of merchandise is exemplified as taxation target information in which a tax amount is calculated by being multiplied by a tax rate; however, also the taxation target information is not limited to the weight of merchandise. For example, a tax amount may be calculated by multiplying the volume of merchandise by a tax rate. In this case, the taxation target information is defined as the volume of merchandise.

In addition, in the embodiment, a processing device which is centrally managed by a store server, a so-called POS terminal is exemplified; however, it is also possible to apply the same embodiment to an electronic cash register of a single body. In addition, it is also possible to apply the embodiment to a measurement-type label printer which measures a weight of merchandise and issues a pricing label by calculating a price based on the weight.

In addition, in general, transfer of a processing device is performed in a state in which a program is stored in a ROM. However, there is no limitation to using this method, and a program, or the like, which is transferred separately from a computer device may be written into a writable storage unit which is included in the computer device according to an operation of a user, or the like. Transfer of a program, or the like, can be performed by recording the program in a removable recording medium, or using communication through a network. The form of the recording medium is not particularly limited when the recording medium can store a program such as a CD-ROM, and a memory card, and can be read using a device. In addition, functions which are obtained by installing or downloading a program may be executed in cooperation with an operating system (OS), or the like, in the device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A merchandise sales data processing device comprising:
a specification unit which specifies merchandise;
a detection unit which detects information related to an ingredient which is contained in the merchandise which is specified using the specification unit;
a calculation unit which calculates a tax amount which is imposed on the merchandise based on the ingredient information which is detected using the detection unit; and
a processing unit which processes sales data of the merchandise using a tax amount which is calculated using the calculation unit.

2. The device according to claim 1,
wherein the calculation unit determines the tax rate from the ingredient information, and calculates the tax amount by multiplying the amount of the merchandise by the tax rate.

3. The device according to claim 1,
wherein the specification unit receives an input of a merchandise code which includes ingredient information of the merchandise, and
wherein the detection unit detects the ingredient information from the merchandise code.

4. The device according to claim 1,
wherein the specification unit receives input of a merchandise code which includes the ingredient information and the amount of the merchandise,
wherein the detection unit detects the ingredient information from the merchandise code, and
wherein the calculation unit detects the amount from the merchandise code, determines the tax rate from the ingredient information, and calculates the tax rate by multiplying the amount of the merchandise by the tax rate.

5. The device according to claim 1,
wherein the ingredient information is the density of any one of saturated fatty acid, sugar, salt, and calories.

6. A program causing a computer to realize:
a function of specifying merchandise;
a function of detecting information of an ingredient which is contained in the specified merchandise;
a function of calculating a tax amount which is imposed on the merchandise based on the ingredient information; and
a function of processing sales data of the merchandise using a price including the tax amount.
